(19) United States
(12) Patent Application Publication
(10) Pub. No.: US 2010/0177596 A1
(43) Pub. Date: Jul. 15, 2010

(54) Adaptive Carrier Modulation for Wellbore Acoustic Telemetry

(75) Inventors: Kevin D. Fink, Frisco, TX (US); Pirooz Najafi, Plano, TX (US)

Correspondence Address: SMITH IP SERVICES, P.C., P.O. Box 997, Rockwall, TX, 75087, US

(73) Assignee: HALLIBURTON ENERGY SERVICES, INC., Carrollton, TX (US)

(21) Appl. No.: 12/353,710

(22) Filed: Jan. 14, 2009

(51) Int. Cl. G01V 1/40

(52) U.S. Cl. 367/81

(57) ABSTRACT

Systems and methods of adaptive carrier modulation for acoustic telemetry. A method of transmitting an acoustic signal through a wellbore medium includes propagating the acoustic signal through the wellbore medium, the acoustic signal including symbols modulated on a carrier frequency, and the carrier frequency being changed during transmission of each of the symbols. A wellbore acoustic telemetry system includes a transmitter which propagates an acoustic signal through a wellbore medium in a manner such that the acoustic signal includes symbols modulated on a carrier frequency, with the carrier frequency being changed during transmission of each of the symbols.

### BACKGROUND

The present disclosure relates generally to equipment and procedures utilized in conjunction with a subterranean well and, in an embodiment described herein, more particularly provides adaptive carrier modulation for wellbore acoustic telemetry.

Presently, wellbore communication systems use digital modulation methods which involve modulating data with a carrier signal. The carrier signal is typically comprised of a single or dual frequency source. Modulation methods, such as frequency-shift keying (FSK), amplitude-shift keying (ASK), phase-shift keying (PSK) and their derivatives, all use some form of this basic carrier-based modulation. Some of these methods use a single frequency source, and others use two or more frequencies, but over a narrow band.

One challenge in using these types of single or dual-frequency modulation techniques is that the wellbore is not a particularly good transmission medium for these signals. In the past, there have been numerous attempts to solve this problem, with only limited success.

The primary method used previously was to perform some form of calibration of the communication system, wherein the overall frequency spectrum of the medium was determined, and then an acceptable transmission carrier frequency was selected based on that information. The main difficulty with this method is that, in wellbore communication systems, the properties or the medium change along with changes in fluid, flow rate, stress, temperature and other factors that are dynamic in nature.

In addition, the frequency calibration techniques used previously required significant time to determine the frequency spectrum of the medium, select a proper transmission carrier frequency, test the communication system using the selected carrier, and then repeat the selection-test cycle until an acceptable carrier frequency was found. All of this was performed under a static set of wellbore conditions. Once those conditions changed, the process needed to be repeated.

Therefore, it will be appreciated that improvements are needed in the art of wellbore telemetry systems.

### SUMMARY

This disclosure describes a method of overcoming prior problems in a straightforward, yet very effective, way. In very basic terms, a transmitted carrier signal is no longer a single frequency signal, but instead comprises a broad sweep of frequencies.

Standard modulation techniques may still be used to modulate the amplitude, phase, or even frequency of the signal to convey information. Thus, the receiver can use standard signal detection methods, if desired.

A method described in this disclosure overcomes past problems of wellbore telemetry systems, in that it is not a static solution. Instead, transmitting broadband signals allows the communication system to account for the dynamic nature of the wellbore, in that the transmitted carrier frequency may appear to shift, but a broad range of frequencies is shifted, which the receiver is still able to detect.

For example, in prior telemetry systems, a conventional receiver might be configured to detect any signal over a frequency band of 20 Hz, starting at 1000 Hz (i.e., the receiver will detect any signal from 990 Hz to 1010 Hz). A conventional transmitter may transmit at 1000 Hz, but the frequency of the signal at the receiver may appear to shift to 1020 Hz. As a result, the receiver will not accurately detect and decode the data from the transmitter.

However, using the principles described in this disclosure, a transmitter can transmit a broadband swept-frequency from 980 Hz to 1020 Hz. If the frequency of this signal appears to shift by 20 Hz as before, the signal frequency at the receiver will range from 1000 Hz to 1040 Hz. Since the receiver is capable of detecting frequencies over the range of 990 Hz to 1010 Hz, the transmitted signal can be accurately detected and decoded.

It will be appreciated, then, that in the present specification, methods and systems are provided which solve substantial problems in the art of wellbore telemetry. One example is described below in which a carrier frequency is varied while a symbol (e.g., a bit) of an acoustic signal is transmitted. Another example is described below in which the symbol value may be represented by a phase, amplitude, frequency, etc. of the acoustic signal.

In one aspect, a method of transmitting an acoustic signal through a wellbore medium (tubing, pipe, casing and/or fluid) is provided. The method includes propagating the acoustic signal through the wellbore medium. The acoustic signal includes symbols modulated on a carrier frequency, and the carrier frequency is changed during transmission of each of the symbols.

The carrier frequency may be varied so that, at every point in time during transmission of the symbols, only a single frequency is transmitted. The carrier frequency may be changed incrementally or gradually during transmission of each of the symbols.

The carrier frequency may be increased, decreased, increased and decreased, alternately increased and decreased, increased and then maintained substantially constant, or decreased and then maintained substantially constant, during transmission of each of the symbols.

It is not necessary for the carrier frequency to be varied during transmission of all symbols included in the acoustic signal. Instead, the acoustic signal can include symbols for which the carrier frequency is maintained substantially constant during transmission of each of the symbols.

In another aspect of this disclosure, a wellbore acoustic telemetry system is provided which includes a transmitter which propagates an acoustic signal through a wellbore medium in a manner such that the acoustic signal includes symbols modulated on a carrier frequency, with the carrier frequency being changed during transmission of each of the symbols.

The principles of this disclosure can be adapted for use with other types of telemetry systems, such as electromagnetic, tubing manipulation and pressure pulse telemetry systems.

These and other features, advantages and benefits will become apparent to one of ordinary skill in the art upon careful consideration of the detailed description of representative embodiments below and the accompanying drawings, in which similar elements are indicated in the various figures using the same reference numbers.

### BRIEF DESCRIPTION OF THE DRAWINGS

FIG. 1 is a schematic partially cross-sectional view of a wellbore acoustic telemetry system embodying principles of the present disclosure; and

FIGS. 2-6 are schematic diagrams of portions of an acoustic signal which may be propagated through a wellbore medium in the system of FIG. 1.

### DETAILED DESCRIPTION

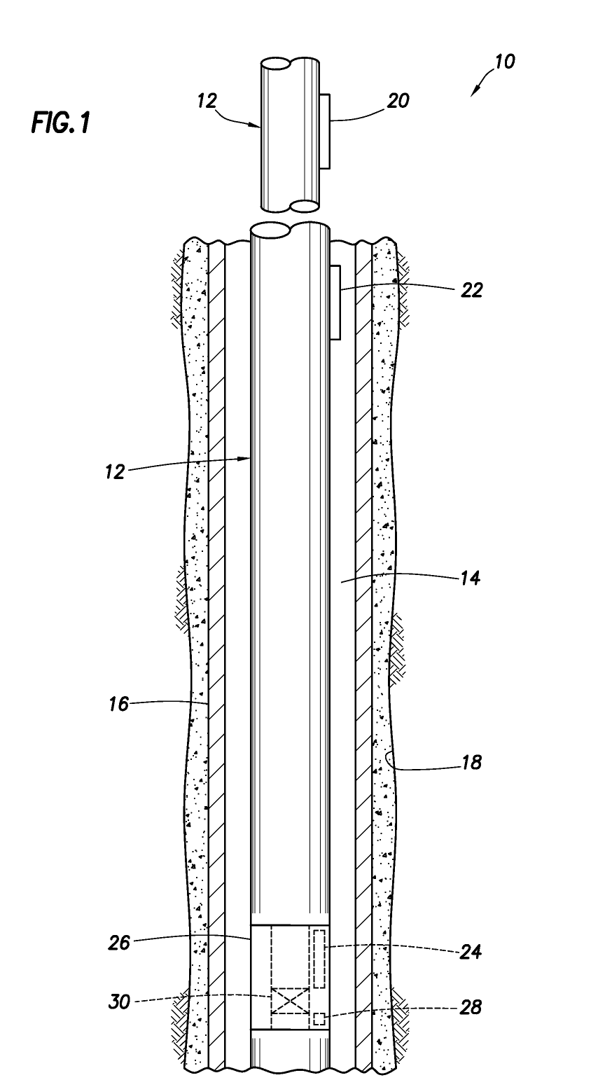

Representatively illustrated in FIG. 1 is a wellbore acoustic telemetry system 10 which embodies principles of the present disclosure. In the system 10, acoustic signals are transmitted through wellbore medium, such as a tubular string 12, fluid in an interior of the tubular string and/or in an annulus 14 formed between the tubular string and casing 16 lining a wellbore 18.

The acoustic signal is transmitted between acoustic transceivers (transmitters/receivers) 20, 22, 24. For example, the transceiver 20 may be located at the earth's surface, a seabed facility, or another remote location, and may be used to collect data transmitted from within the wellbore 18 or to transmit commands to operate a well tool 26 interconnected in the tubular string 12.

The transceiver 22 may be of the type known to those skilled in the art as a repeater. As such, the transceiver 22 can receive data/information/commands transmitted from either of the transceivers 20, 24 and re-transmit the data/information/commands to the other of the transceivers. Multiple repeaters can be used if needed to relay an acoustic signal across long distances.

The transceiver 24 can be associated with the well tool 26, for example, to transmit data acquired by a sensor 28, to receive commands for operation of a component (such as a valve 30) of the well tool, etc. Many other uses for downhole acoustic telemetry transmitters and receivers are possible in the system 10, and in other systems incorporating the principles of this disclosure.

Preferably, each of the transceivers 20, 22, 24 includes both an acoustic transmitter and an acoustic receiver, although a receiver can be used apart from a transmitter, and a transmitter can be used apart from a receiver, in keeping with the principles of this disclosure. The transceivers 20, 22, 24 may be otherwise conventional in design, and so will not be described in further detail here, but it should be understood that any type of acoustic transmitter, receiver and/or transceiver may be used.

Suitable acoustic telemetry transmitters, receivers and transceivers are described in U.S. published application nos. 2006-0028916, 2008-0030367 and 2008-0031091, and in U.S. Pat. Nos. 6,434,084, 6,470,996 and 7,357,021. The entire disclosures of these prior applications and patents are incorporated herein by this reference.

Each of the transceivers 20, 22, 24 is depicted in FIG. 1 as being coupled to the tubular string 12, and in this manner the acoustic signal can be transmitted via the tubular string. However, in other examples, the transceivers 20, 22, 24 could be otherwise connected, the acoustic signal could be transmitted via the casing 16 and/or via fluid in the annulus 14 or in the interior of the tubular string, etc. Thus, it will be appreciated that the system 10 as schematically represented in FIG. 1 is merely one example of a wide variety of systems which can incorporate the principles of this disclosure.

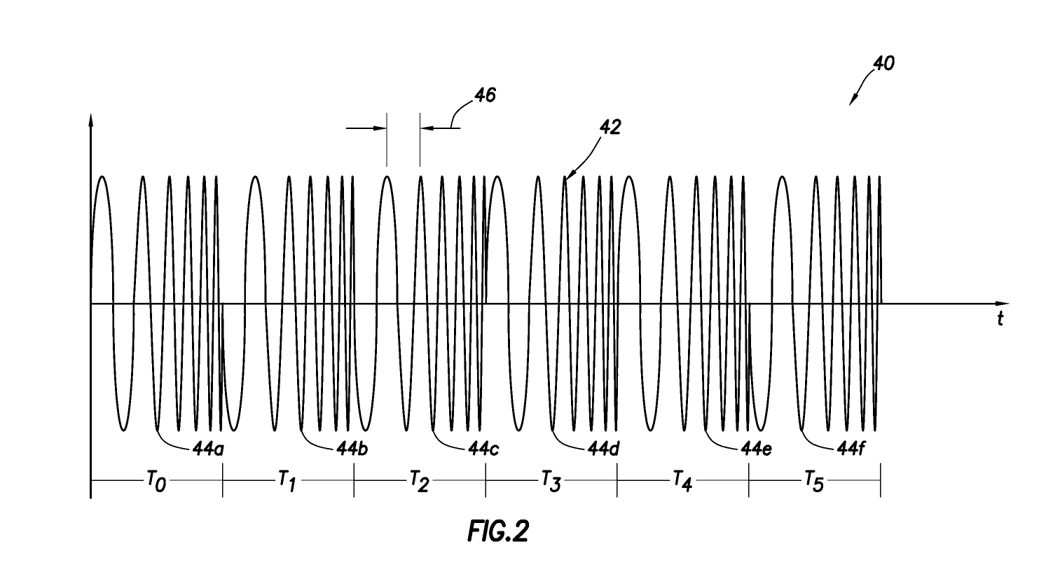

Referring additionally now to FIG. 2, a first example of an acoustic signal 40 which may be propagated through a wellbore medium in the system 10 of FIG. 1 is representatively illustrated. The acoustic signal 40 can be transmitted from any of the transceivers 20, 22, 24, can be received by any of the transceivers, and can be transmitted via any wellbore medium (such as the tubular string 12, casing 16, fluid in the annulus 14 and/or fluid in the tubular string, etc.).

In FIG. 2, a portion of the acoustic signal 40 is represented as a waveform 42, with a vertical axis indicating amplitude and a horizontal axis indicating time. In this portion of the acoustic signal 40, six symbols 44a-f are transmitted during corresponding time periods T₀₋₅. The symbols 44a-f could comprise, for example, bits (0 or 1) of information, data, etc., although other types of symbols may be transmitted in keeping with the principles of this disclosure.

The waveform 42 may result from detection of pressure waves in the tubular string 12, casing 16, fluid in the annulus 14 and/or fluid in the tubular string, etc. Alternatively, the waveform 42 could result from detection of stress waves in the tubular string 12 and/or casing 16, etc. Any method of detecting the acoustic signal 40 may be used in keeping with the principles of this disclosure.

In the example of FIG. 2, phase-shift keying is used to modulate the symbols 44a-f on a carrier frequency 46 which changes while each symbol is being transmitted (the reference number 46 in the drawings actually indicates a period of the waveform 42, which is the inverse of the frequency, for illustrative clarity). As depicted in FIG. 2, symbols 44a, d and e have one phase (with a beginning positive amplitude), and symbols 44b, c and f have an opposite phase (beginning with a negative amplitude).

Those skilled in the art will appreciate that such phase-shift keying can be used in various ways to transmit information, data, commands, etc. in an acoustic telemetry system. It should also be appreciated that other techniques (such as amplitude-shift keying, frequency-shift keying and/or derivatives and combinations thereof) may be used to transmit information, data, commands, etc. using the principles of this disclosure.

Note that, in each of the time periods T₀₋₅, the carrier frequency 46 changes. In this example, the frequency 46 increases while each of the symbols 44a-f is being transmitted.

However, it should also be noted that, at every point in time during the transmission of each symbol, only a single frequency is transmitted. Thus, a range of frequencies are transmitted for each symbol, but multiple frequencies are not simultaneously transmitted for each symbol. In other examples, simultaneous transmission of multiple frequencies could be used, if desired.

In the embodiment of FIG. 2, the frequency 46 could be swept from 980 Hz to 1020 Hz during transmission of each of the symbols 44a-f. In this manner, a receiver which is capable of detecting frequencies in the range of 990-1010 Hz could still accurately detect and decode the signal 40, even if the transmitted frequency 46 were to be shifted by 20 Hz by the wellbore medium.

Of course, other frequency ranges may be used, if desired. For example, the range of transmitted frequency sweep could be 5 or 10 Hz, which may be appropriate for many wellbore configurations.

Preferably, the carrier frequency 46 is incrementally increased as each symbol 44a-f is transmitted (for example, in 1 HZ increments). However, the carrier frequency 46 could be changed in a continuously variable or other gradual manner, if desired.

As described more fully below, the carrier frequency 46 can alternatively, or additionally, be increased, decreased, increased and decreased, alternately increased and decreased, increased and then maintained substantially constant, or decreased and then maintained substantially constant, during transmission of each of the symbols 44a-f. In each of these examples, the carrier frequency 46 can be incrementally, gradually or otherwise varied during transmission of each of the symbols 44a-f.

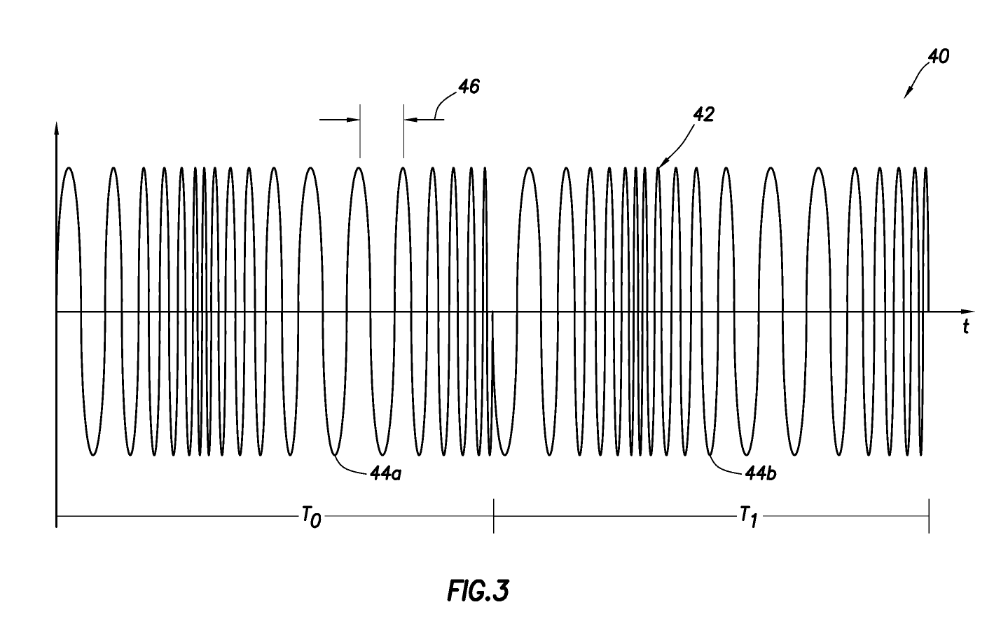

Referring additionally now to FIG. 3, the waveform 42 is representatively illustrated with only time periods T₀ and T₁ being depicted. In this example, the carrier frequency 46 is increased, then decreased, and then increased again during transmission of each of the symbols 44a,b.

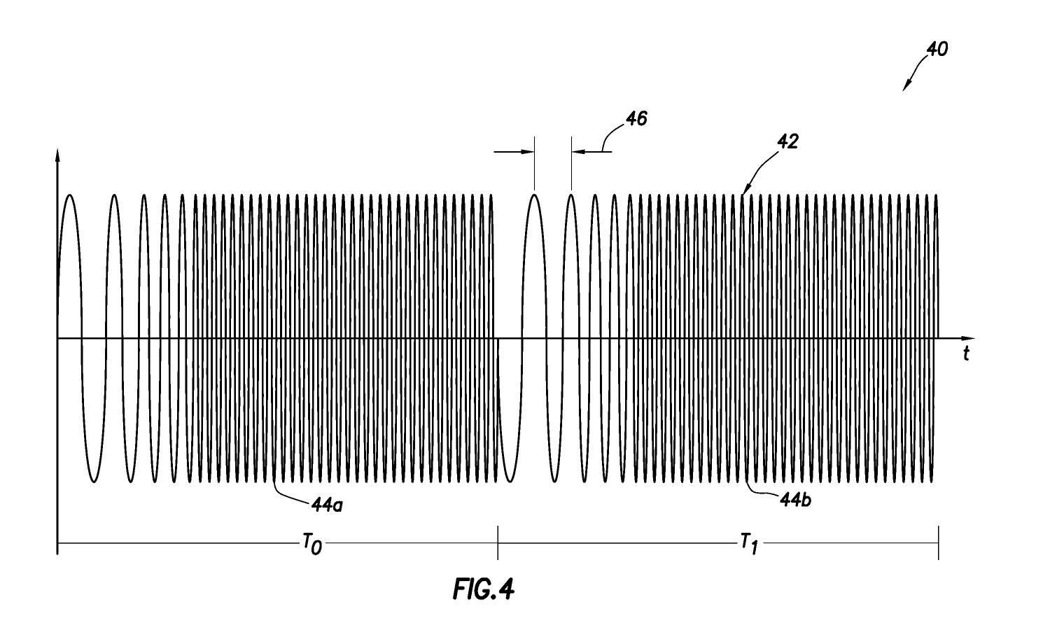

In FIG. 4, the carrier frequency 46 is increased, and then maintained substantially constant, during transmission of each of the symbols 44a,b.

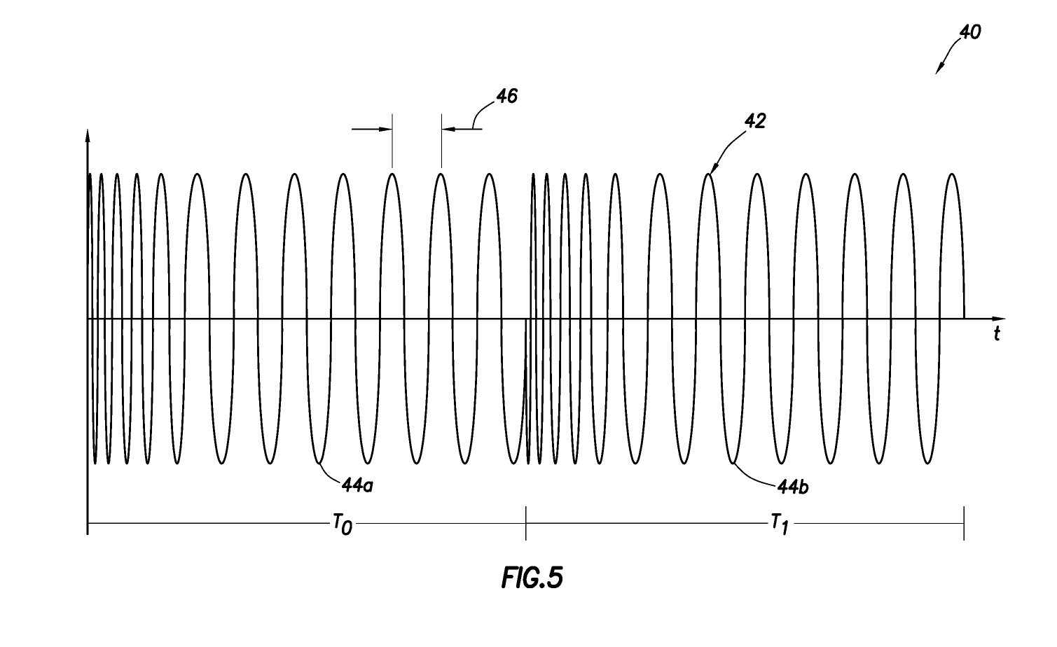

In FIG. 5, the carrier frequency 46 is decreased, and then maintained substantially constant, during transmission of each of the symbols 44a,b.

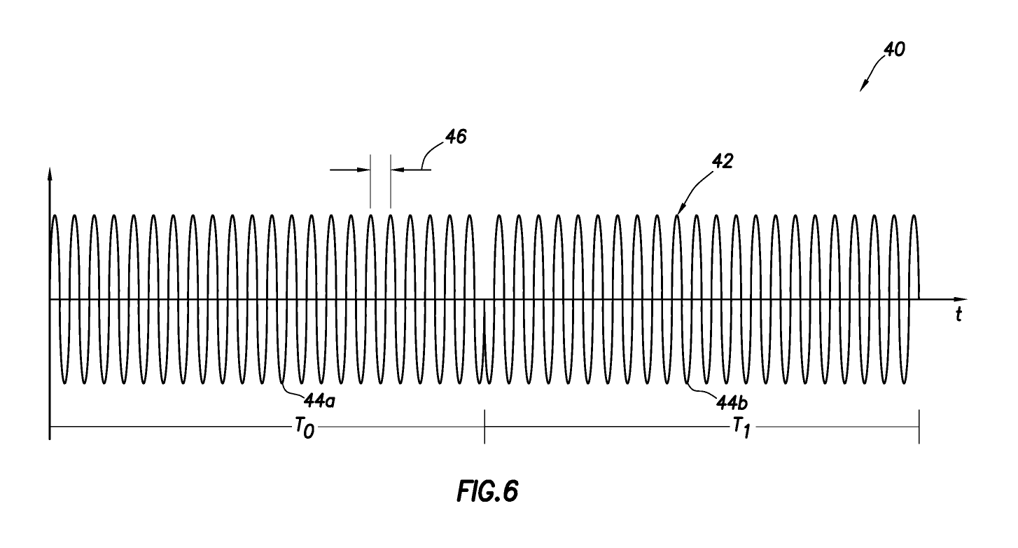

In FIG. 6, the carrier frequency 46 is maintained substantially constant during transmission of the each of the symbols 44a,b. This example demonstrates that it is not strictly necessary for the carrier frequency 46 to be changed during transmission of every symbol in an acoustic signal.

In some portions of the acoustic signal 40, the carrier frequency 46 could be fixed, for example, in a synchronization portion of the signal. Thus, it should be understood that the acoustic signal 40 can include any of the examples described above and illustrated in FIGS. 2-6, and in any combination or order, in keeping with the principles of this disclosure.

It can now be fully appreciated that the above description provides advancements to the art of wellbore acoustic telemetry. Some of the benefits obtained from utilization of the principles described in this disclosure include improved reliability of communication with fewer bit errors, and increased data rate capabilities due to the higher reliability of carrier frequency reception.

In particular, the above disclosure describes a method of transmitting an acoustic signal 40 through a wellbore medium (such as the tubular string 12, casing 16, fluid in the annulus 14 and/or fluid in the tubular string, etc.). The method includes propagating the acoustic signal 40 through the wellbore medium, with the acoustic signal 40 including symbols 44a-f modulated on a carrier frequency 46, and the carrier frequency 46 being changed during transmission of each of the symbols 44a-f.

The carrier frequency 46 may be varied so that, at every point in time during transmission of the symbols 44a-f, only a single frequency is transmitted.

The carrier frequency 46 may be changed incrementally or gradually during transmission of each of the symbols 44a-f.

The carrier frequency 46 may be increased, decreased, increased and decreased, alternately increased and decreased, increased and then maintained substantially constant, and/or decreased and then maintained substantially constant, during transmission of each of the symbols 44a-f.

The acoustic signal 40 may further include symbols 44a,b for which the carrier frequency 46 is maintained substantially constant during transmission of each of the symbols.

Also described above is a wellbore acoustic telemetry system 10. The system 10 includes a transmitter (such as transceivers 20, 22, 24) which propagates an acoustic signal 40 through a wellbore medium (such as the tubular string 12, casing 16, fluid in the annulus 14 and/or fluid in the tubular string, etc.) in a manner such that the acoustic signal 40 includes symbols 44a-f modulated on a carrier frequency 46, with the carrier frequency being changed during transmission of each of the symbols.

The system 10 can also include a receiver (such as transceivers 20, 22, 24) which detects and decodes the acoustic signal 40. The system 10 can also include a repeater (such as transceiver 22) which detects and relays the acoustic signal 40.

Although the above description relates to acoustic telemetry systems, the concepts described above could also be used to benefit electromagnetic, tubing manipulation, pressure pulse or other types of telemetry systems. For example, in an electromagnetic telemetry system, the electromagnetic signal (e.g., a radio frequency signal) could be propagated, with the signal including symbols modulated on a carrier frequency, and the carrier frequency being changed during transmission of each of the symbols. The modulation could be performed using any of the techniques described above for the acoustic signal 40.

It is to be understood that the various embodiments described herein may be utilized in various orientations, such as inclined, inverted, horizontal, vertical, etc., and in various configurations, without departing from the principles of the present disclosure. The embodiments are described merely as examples of useful applications of the principles of the disclosure, which are not limited to any specific details of these embodiments.

Of course, a person skilled in the art would, upon a careful consideration of the above description of representative embodiments, readily appreciate that many modifications, additions, substitutions, deletions, and other changes may be made to these specific embodiments, and such changes are within the scope of the principles of the present disclosure. Accordingly, the foregoing detailed description is to be clearly understood as being given by way of illustration and example only, the spirit and scope of the present invention being limited solely by the appended claims and their equivalents.

What is claimed is:

1. A method of transmitting an acoustic signal through a wellbore medium, the method comprising:
propagating the acoustic signal through the wellbore medium, the acoustic signal including symbols modulated on a carrier frequency, and the carrier frequency being changed during transmission of each of the symbols.

2. The method of claim 1, wherein the carrier frequency is varied so that, at every point in time during transmission of the symbols, only a single frequency is transmitted.

3. The method of claim 1, wherein the carrier frequency is changed incrementally during transmission of each of the symbols.

4. The method of claim 1, wherein the carrier frequency is changed gradually during transmission of each of the symbols.

5. The method of claim 1, wherein the carrier frequency is increased during transmission of each of the symbols.

6. The method of claim 1, wherein the carrier frequency is decreased during transmission of each of the symbols.

7. The method of claim 1, wherein the carrier frequency is increased and decreased during transmission of each of the symbols.

8. The method of claim 1, wherein the carrier frequency is alternately increased and decreased during transmission of each of the symbols.

9. The method of claim 1, wherein the carrier frequency is increased and then maintained substantially constant during transmission of each of the symbols.

10. The method of claim 1, wherein the carrier frequency is decreased and then maintained substantially constant during transmission of each of the symbols.

11. The method of claim 1, wherein the acoustic signal further includes symbols for which the carrier frequency is maintained substantially constant during transmission of each of the symbols.

12. A wellbore acoustic telemetry system, comprising:
at least one transmitter which propagates an acoustic signal through a wellbore medium in a manner such that the acoustic signal includes symbols modulated on a carrier frequency, with the carrier frequency being changed during transmission of each of the symbols.

13. The system of claim 12, wherein the carrier frequency is varied so that, at every point in time during transmission of the symbols, only a single frequency is transmitted.

14. The system of claim 12, wherein the carrier frequency is changed incrementally during transmission of each of the symbols.

15. The system of claim 12, wherein the carrier frequency is changed gradually during transmission of each of the symbols.

16. The system of claim 12, wherein the carrier frequency is increased during transmission of each of the symbols.

17. The system of claim 12, wherein the carrier frequency is decreased during transmission of each of the symbols.

18. The system of claim 12, wherein the carrier frequency is increased and decreased during transmission of each of the symbols.

19. The system of claim 12, wherein the carrier frequency is alternately increased and decreased during transmission of each of the symbols.

20. The system of claim 12, wherein the carrier frequency is increased and then maintained substantially constant during transmission of each of the symbols.

21. The system of claim 12, wherein the carrier frequency is decreased and then maintained substantially constant during transmission of each of the symbols.

22. The system of claim 12, wherein the acoustic signal further includes symbols for which the carrier frequency is maintained substantially constant during transmission of each of the symbols.

23. The system of claim 12, further comprising a receiver which detects and decodes the acoustic signal.

24. The system of claim 12, further comprising a repeater which detects and relays the acoustic signal.
